(19) United States
(12) Patent Application Publication
(10) Pub. No.: US 2007/0120383 A1
(43) Pub. Date: May 31, 2007

(54) Bumper system

(75) Inventors: Kenneth R. Schmidt, Plymouth, MI (US); Christopher Pelto, Chesterfield, MI (US); Bradley Hamlin, Canton, MI (US); Rajesh Tagore, Farmington Hills, MI (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Meridian Automotive Systems, Inc., Allen Park, MI (US)

(21) Appl. No.: 11/588,082

(22) Filed: Oct. 26, 2006

Related U.S. Application Data
(60) Provisional application No. 60/730,327, filed on Oct. 26, 2005.

(51) Int. Cl. B60R 19/56

(52) U.S. Cl. 293/102

(57) ABSTRACT

The embodiments provide bumper systems, as well as methods of making bumper systems. The bumper systems include an inner panel and an outer panel, each with a first end and a second end. The outer panel can then comprise a substantially uniform cross-section between the first end and the second end, and the inner panel can also comprise a substantially uniform cross-section between the first end and the second end.

### RELATED APPLICATIONS

This application claims the benefit of U.S. Provisional Application 60/730,327, filed Oct. 26, 2005, the entirety of the previously filed application being incorporated herein by reference.

### BACKGROUND

1. Field of the Invention

The present invention relates to the field of modular bumper systems.

2. Background

Bumpers are an integral part of any vehicle. The primary function of a bumper is to absorb and distribute impact loading during a collision, thus providing an important safety feature of the vehicle. While a bumper can assume a variety of configurations for providing safety, it is often desirable that the shape of the bumper conform to the overall styling of the vehicle. Additionally, reducing the bumper weight is an important consideration (for meeting fuel efficiency standards, for example).

Bumpers have traditionally been roll formed or stamped from a single blank of material such as steel, and are rigidly attached to a frame of a vehicle. A roll formed bumper generally takes the shape of an arch, with a front beam or panel of the bumper forming an apex of the arch that faces forward toward the direction of travel. The bumper can then absorb impact loading through deformation, i.e., flattening, of the arch. However, flattening of the bumper under impact loading will tend to push the vehicle frame elements outward, thus causing considerable structural damage.

Resistance of the bumper to deformation under impact loading is generally a function of the size, shape, and strength of the material forming the bumper. Since the strength of the bumper is directly related to its size, it is difficult to obtain a bumper of sufficient strength while at the same time minimizing its weight and thus improving the vehicle's fuel efficiency. U.S. Pat. No. 6,926,320 (assigned to Meridian Automotive Systems, Inc.) provides examples and descriptions of the general background of bumper systems, and the specification of this patent is incorporated herein by reference as though set forth here in full.

One bumper system design consideration is impact performance. It is preferable that the front beam or panel of a bumper system meet vehicle manufacturer specifications, such as a barrier impact test (a flat plate impact test) or a pendulum impact test (a weighted device that swings into a vehicle), without damaging adjacent systems.

Other bumper system design considerations include noise, vibration, and harshness (“NVH”) considerations. The front beam or panel of a bumper system is the first cross member of the vehicle frame and is an integral component of front-end frame characteristics. The bumper beam design must also accommodate studio design constraints, which can include aesthetic characteristics (such as a highly swept front end and an increased vehicle length, for example).

Past attempts to solve these functional and aesthetic design constraints have fallen short. For example, bumper systems have employed a roll formed beam in a B-shaped section, but a roll formed B-shaped beam is difficult to make, cannot be swept (or arched) easily, and has a high weight for its given performance. Bumper systems have also employed a roll formed beam in a box-shaped section, but a roll formed box-shaped beam also cannot be easily swept and has reduced angle barrier performance (more deflection during corner or angle barrier impact tests). Other bumper systems have used a roll formed beam (with any shape cross-section) with stamped end cap portions. Although the stamped end cap portions can provide more strength and a shape that fits under a vehicle fascia, these beams also cannot be easily swept and have a higher cost than other designs. Likewise, extruded bumper beams (such as extruded aluminum bumper beams) also have a higher cost than other designs. Other structures, such as energy management isolators that fit between a bumper beam and a vehicle fascia and that can reduce deflection during an impact, also add weight and cost to the bumper system. Accordingly, a bumper system is desired solving the aforementioned problems.

### SUMMARY

In one embodiment, there is provided a bumper system comprising an outer panel with a length extending from a first end to a second end, the outer panel comprising a substantially uniform cross-section between the first end and the second end; an inner panel with a length extending from a first end to a second end, the inner panel comprising a substantially uniform cross-section between the first end and the second end; and wherein the first end of the outer panel is joined to the first end of the inner panel and the second end of the outer panel is joined to the second end of the inner panel.

In another embodiment, there is also provided a bumper system comprising an outer panel extending from a first end to a second end and comprising a substantially uniform cross-section between the first end and the second end; an inner panel extending from a first end to a second end and comprising a substantially uniform cross-section between the first end and the second end; and wherein the outer panel and the inner panel are connected by one or more supports.

In another embodiment, there is also provided a method comprising joining a first end of an outer panel to a first end of an inner panel; joining a second end of the outer panel to a second end of the inner panel; and wherein the outer panel comprises a substantially uniform cross-section between the first end and the second end, and wherein the inner panel comprises a substantially uniform cross-section between the first end and the second end.

### BRIEF DESCRIPTION OF THE DRAWINGS

Embodiments of the present invention are described herein with reference to the drawings, in which:

FIG. 1 depicts an example embodiment of a bumper system for a vehicle;

FIG. 2 depicts an exploded view of the bumper system of FIG. 1;

FIG. 3 depicts an alternate configuration of the bumper system;

FIG. 4 depicts an alternate configuration of the bumper system;

FIG. 5 depicts an alternate configuration of the bumper system;

FIG. 6 depicts an alternate configuration of the bumper system;

FIG. 7 depicts a support for the bumper system;

FIG. 8 depicts a support for the bumper system;

FIG. 9 depicts a support for the bumper system;

FIG. 10 depicts an example embodiment of a crushable module;

FIG. 11 depicts an example embodiment of a crushable module;

FIG. 12 depicts alternate configurations of an outer panel;

FIG. 13 depicts alternate configurations of the outer panel;

FIG. 14 depicts another example of an assembled bumper system;

FIG. 15 depicts an exploded view of the bumper system of FIG. 14;

FIGS. 16A-16D depict several different views of the inner panel of FIG. 15;

FIGS. 17A-17E depict several different views of the outer panel of FIG. 15;

FIGS. 18A-18E depict several different views of the support of FIG. 15;

FIG. 19 depicts a cross-section through the bumper system of FIG. 14;

FIG. 20 depicts an example crushable module;

FIGS. 21A-21D depict several different views of the crushable module of FIG. 20;

FIG. 22 depicts another example of an assembled bumper system;

FIG. 23 depicts an exploded view of the bumper system of FIG. 22;

FIGS. 24A-24D depict several different views of the inner panel of FIG. 23;

FIGS. 25A-25E depict several different views of the outer panel of FIG. 23;

FIGS. 26A-26E depict several different views of the support of FIG. 23; and

FIG. 27 depicts a cross-section through the bumper system of FIG. 22.

### DETAILED DESCRIPTION

The below-described embodiments allow for bumper system construction using bumper beams with uniform cross-sections. In the manner of the examples described below, two bumper beams, each with a uniform cross-section, can be joined to produce a bumper system with a non-uniform cross-section. Thus, the cross-section of the example bumper systems described herein is narrower toward each end and deeper in the middle. Such a bumper system can function like a bumper system manufactured by a different process or using different components, i.e., a bumper system with bumper beams having deeper or non-uniform cross-sections.

In addition, the below-described embodiments can provide several advantages for a bumper system and for a vehicle employing the bumper system. For example, embodiments can provide for a lightweight, truss-type bumper beam, which meets vehicle packaging, strength, and impact requirements. As another example, embodiments can provide for a modular system, allowing different vehicle bumper beams to be manufactured using the same tools. As yet another example, embodiments can provide for a universal bumper beam that can have a common envelope or exterior shape, but that can have different crush modules internally (allowing one to custom tune performance of the bumper system to different vehicle requirements). As still another example, embodiments can provide for a hybrid bumper system that uses steel or aluminum outer panels joined with composite inner modules or supports. Moreover, embodiments can also integrate components in the bumper system to save space, to reduce the number of parts, and to reduce the complexity of assembly; provide high strength to weight ratio; effectively manage the transfer of energy due to impact; protect the surrounding vehicle systems and the vehicle rails; and/or provide high sweep designs that conform to the overall styling of a vehicle.

### FIRST EXAMPLE EMBODIMENT

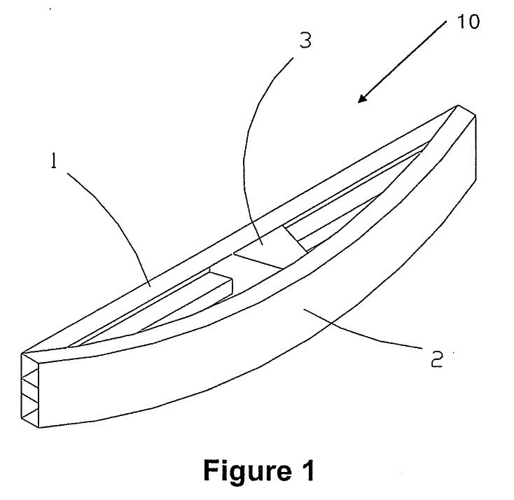

FIG. 1 depicts an example embodiment of a bumper system 10 for a vehicle. The bumper system 10 can be mounted on the front or the back of a vehicle and can absorb some or all of an impact on that vehicle. The bumper system 10 can thus make a vehicle and its occupants safer and can reduce damage to a vehicle resulting from an impact or an accident.

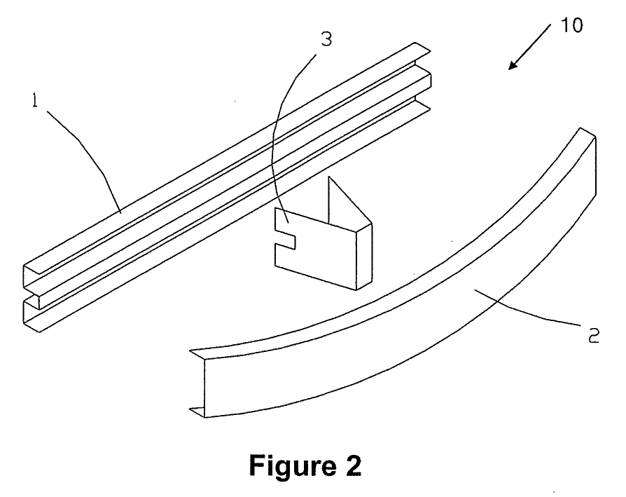

FIG. 2 depicts an exploded view of the bumper system 10 of FIG. 1. The example embodiment of FIGS. 1 and 2 includes an inner panel 1 that mounts to a frame of a vehicle. The inner panel 1 can be a formed open section, such as the W-shaped section depicted in FIG. 2, and can have a uniform or variable cross section. The inner panel 1 can be formed of metal or metal alloys by rolling or stamping, although other examples are possible as well.

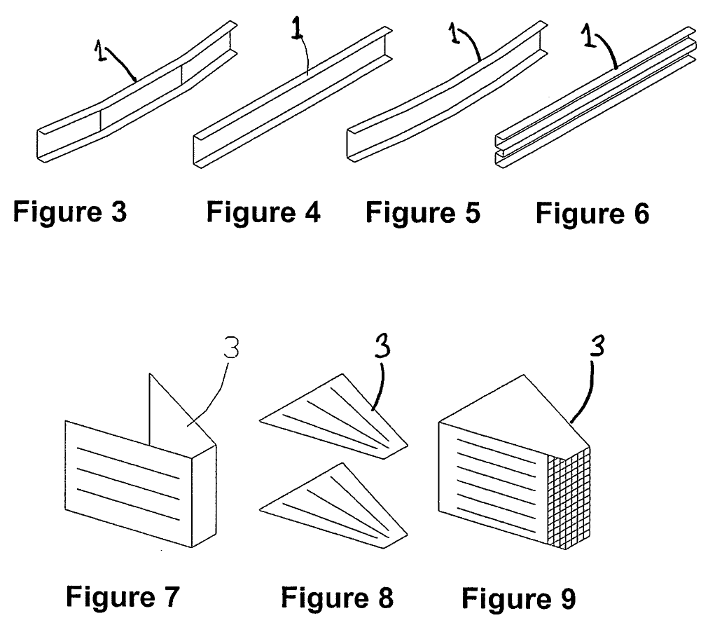

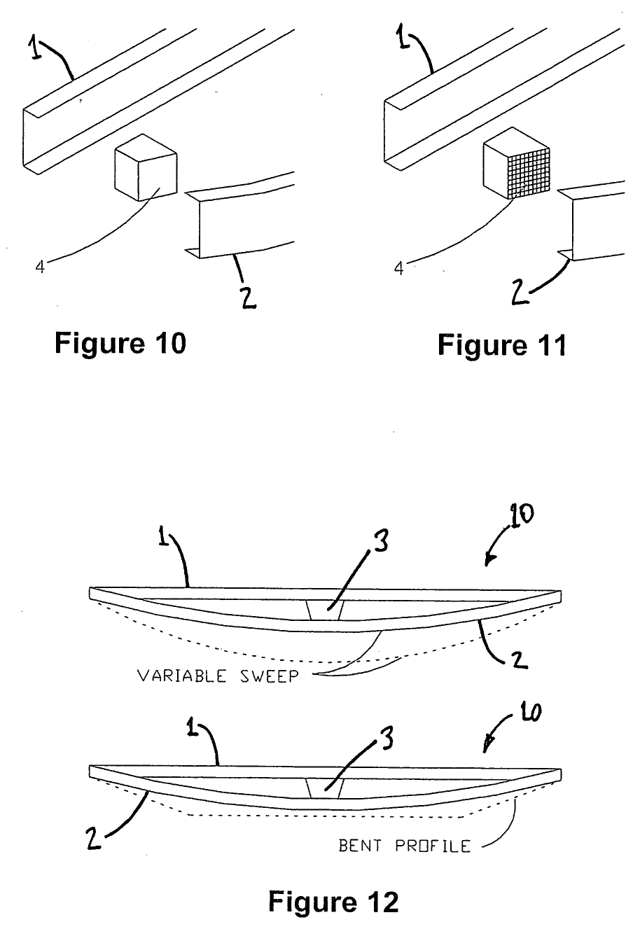

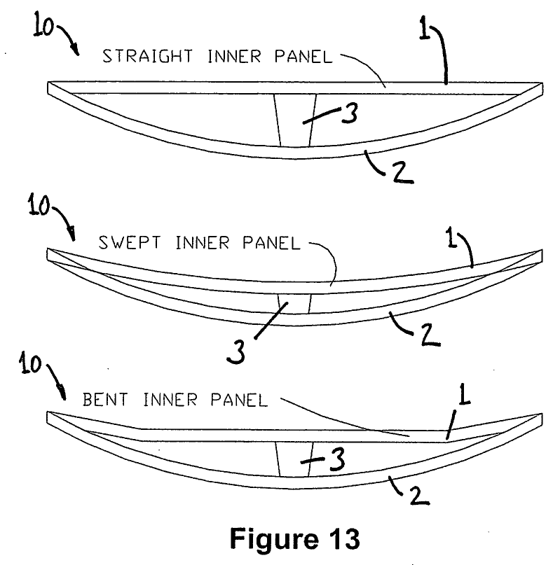

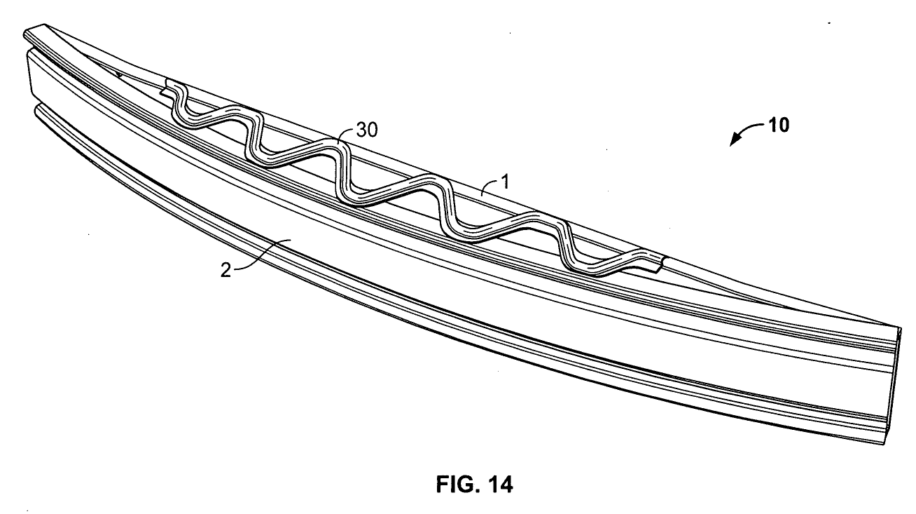

As depicted in FIGS. 3-6, the inner panel 1 can comprise various configurations. For example, the inner panel 1 may be bent, as depicted in FIG. 3, straight, as depicted in FIG. 4, or swept, as depicted in FIG. 5. In some embodiments, the inner panel 1 can be a simple C-shaped section, such as depicted in FIG. 4, or it might include other or additional features and shapes, such as a W-shaped section, as depicted in FIG. 6. Such additional features and shapes can provide additional strength and crush/impact capabilities to the bumper system 10.

Turning back to FIGS. 1 and 2, the example bumper system 10 can further include an outer panel 2, which provides a primary impact surface for the bumper system 10. The outer panel 2 can be a formed open section, such as the C-shaped section depicted in FIG. 2, and can have a uniform or variable cross section. The outer panel 2 can be the same or different gauge as the inner panel 1, and likewise the outer panel 2 can comprise the same or different cross-sectional shape as the inner panel 1. The outer panel 2 can be formed of metal or metal alloys by rolling or stamping, although other examples are possible as well.

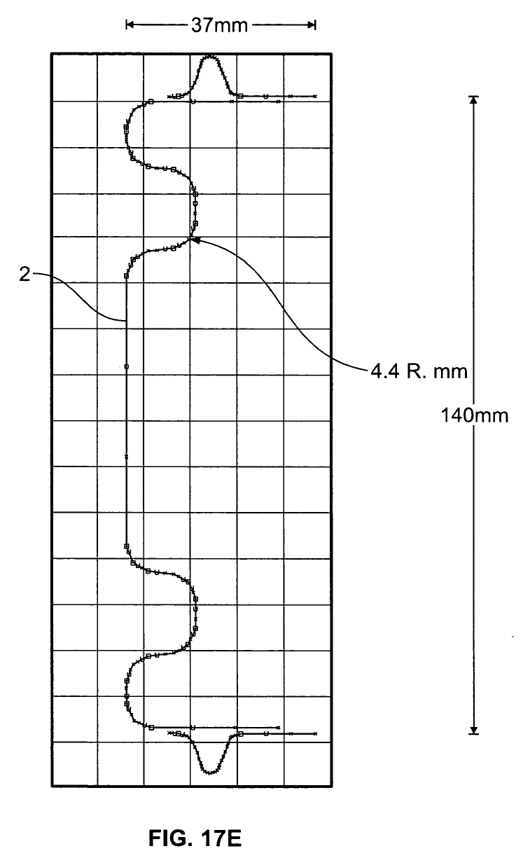

As depicted in FIG. 12, the outer panel 2 can comprise various configurations. For example, the outer panel 2 may be swept (in any of a number of different arcs), as depicted in the upper drawing of FIG. 12, or bent, as depicted in the lower drawing of FIG. 12. In some embodiments, the outer panel 2 can be a simple C-shaped section, such as depicted in FIG. 2, or it might include other or additional features and shapes, such as a W-shaped section, for example. Such additional features and shapes can provide additional strength and crush/impact capabilities to the bumper system 10.

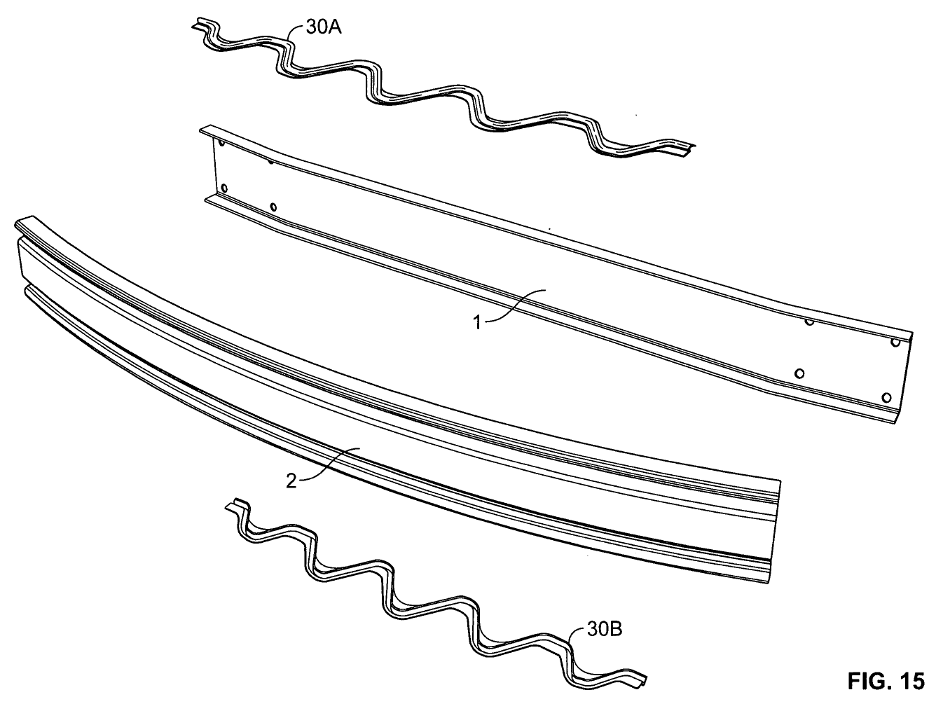

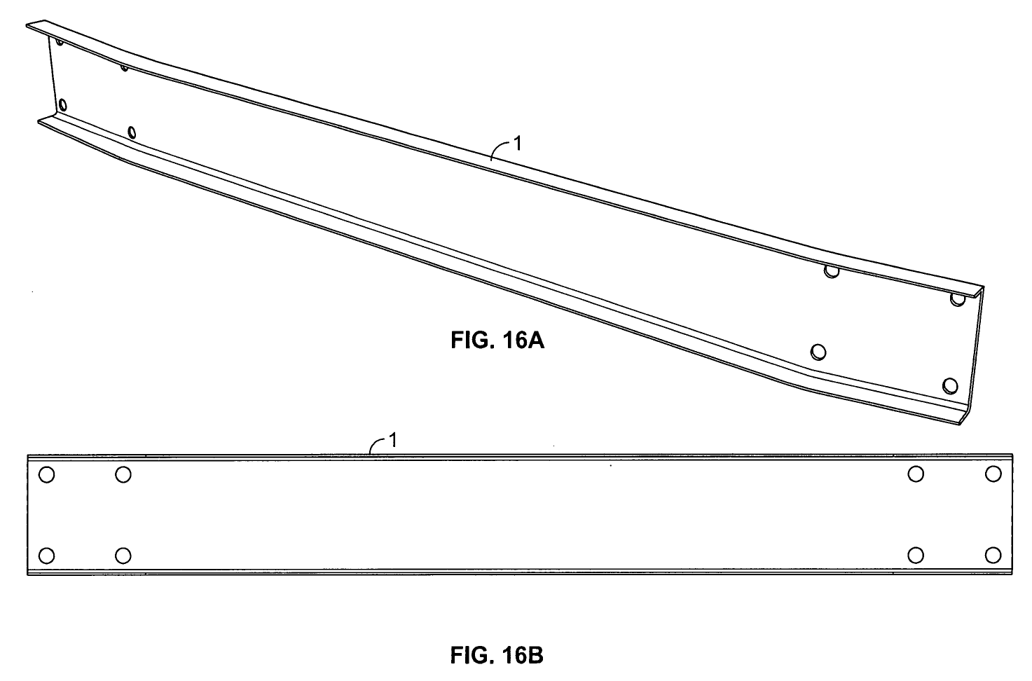

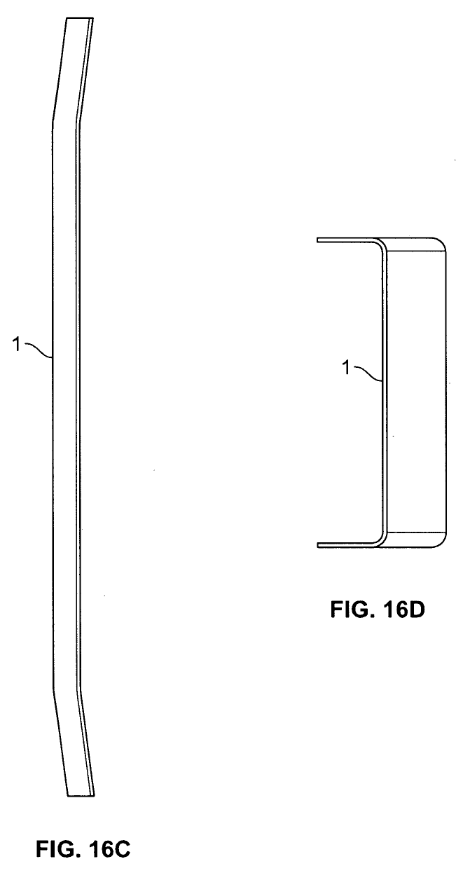

Turning back to FIGS. 1 and 2, the example bumper system 10 can further include at least one support 3. The support 3 can provide a structure between the inner panel 1 and the outer panel 2, and is typically located at the center of the panels, although other locations are possible as well. Although only one support 3 is depicted in FIGS. 1 and 2, in other embodiments there may be more than one support 3 to support the two panels. As depicted in FIGS. 7 and 8, the support 3 may be a single plate, multiple plates, a simple stamping, roll formed, or an engineered, crushable stamping, although other examples and shapes are possible as well. As depicted in FIG. 9, the support 3 may be a simple composite part or an engineered, composite member. A composite support 3 can be made of any composite material or materials, including, for example, injection molding, thermoplastic, or thermoset composite materials.

In any case, the inner panel 1 and the outer panel 2 can also be joined at the outer corners (in addition to being joined at the support 3) to form one complete assembly. Joining methods between the inner panel 1 and the outer panel 2, as well as between the inner panel 1, the outer panel 2, and the support 3, may include welding, mechanical fastening, and bonding. If the support 3 is a composite, it may also be joined to one or both of the inner panel 1 and the outer panel 2 with snap features.

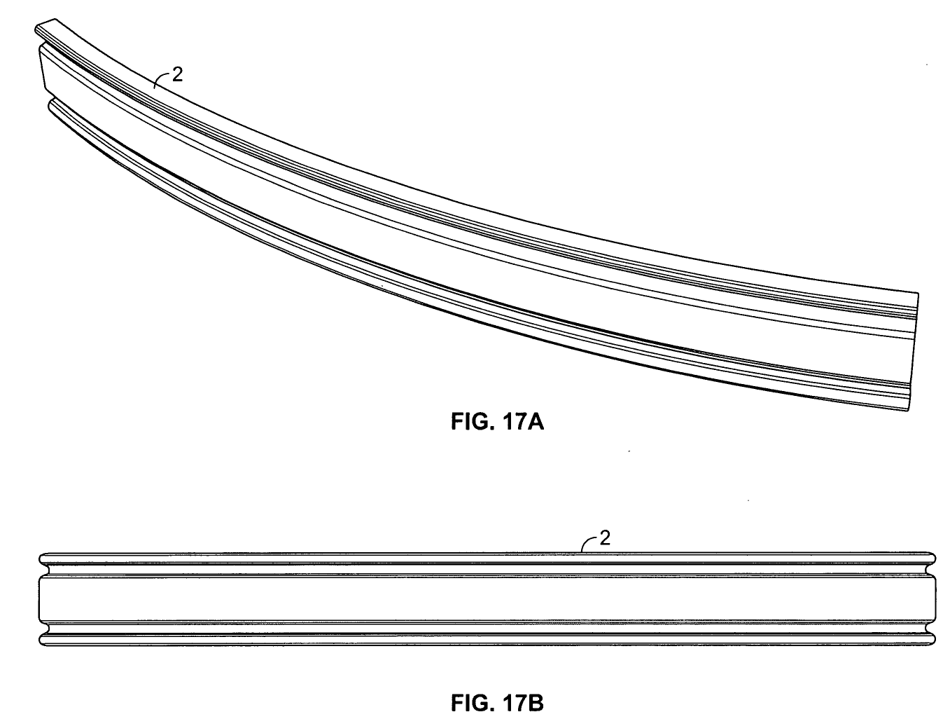

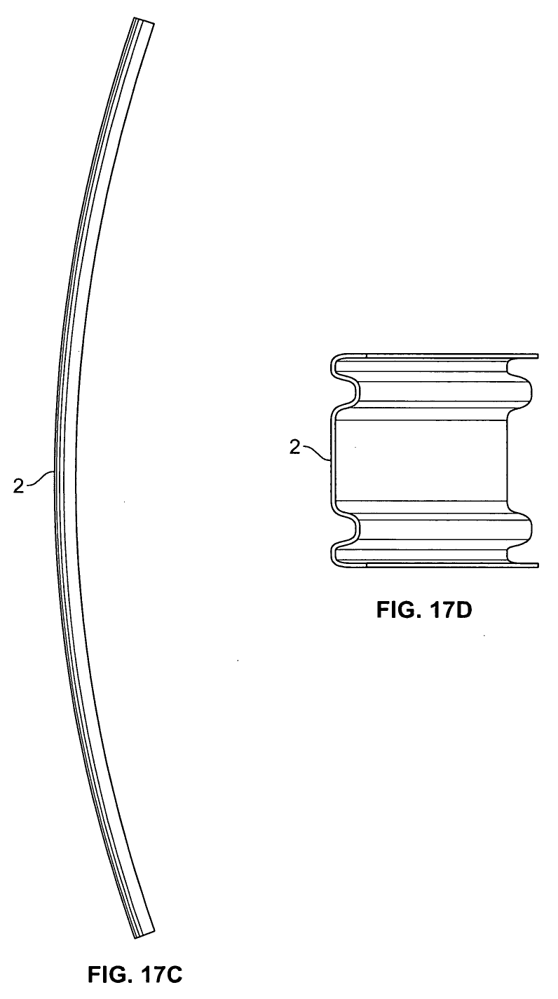

FIGS. 10 and 11 depict example embodiments of crushable modules 4. In some embodiments, one or more modules 4 may be installed between the inner panel 1 and the outer panel 2. The modules 4 can be located at the ends of the inner panel 1 and the outer panel 2, or at the center of the inner panel 1 and the outer panel 2, although other locations are possible as well.

The modules 4 may be a crushable stamping, as depicted in FIG. 10, or an engineered composite part, as depicted in FIG. 11. The modules 4 can provide additional energy management capabilities between the inner panel 1 and the outer panel 2 and to the bumper system 10 (such as for flat and angle barrier impact tests, as well as for pole impact tests (where the vehicle backs into a pole at 5 m.p.h., for example)). By including the modules 4, the gauge of the material of the inner panel 1 and/or the outer panel 2 may be reduced, thereby reducing the weight of the bumper system 10. The modules 4 can also provide support to the inner panel 1 and/or the outer panel 2.

Joining methods between the inner panel 1, the outer panel 2, and the modules 4 can include welding, mechanical fastening, and bonding. If the modules 4 are composite, they may also be joined to one or both of the inner panel 1 and the outer panel 2 with snap features.

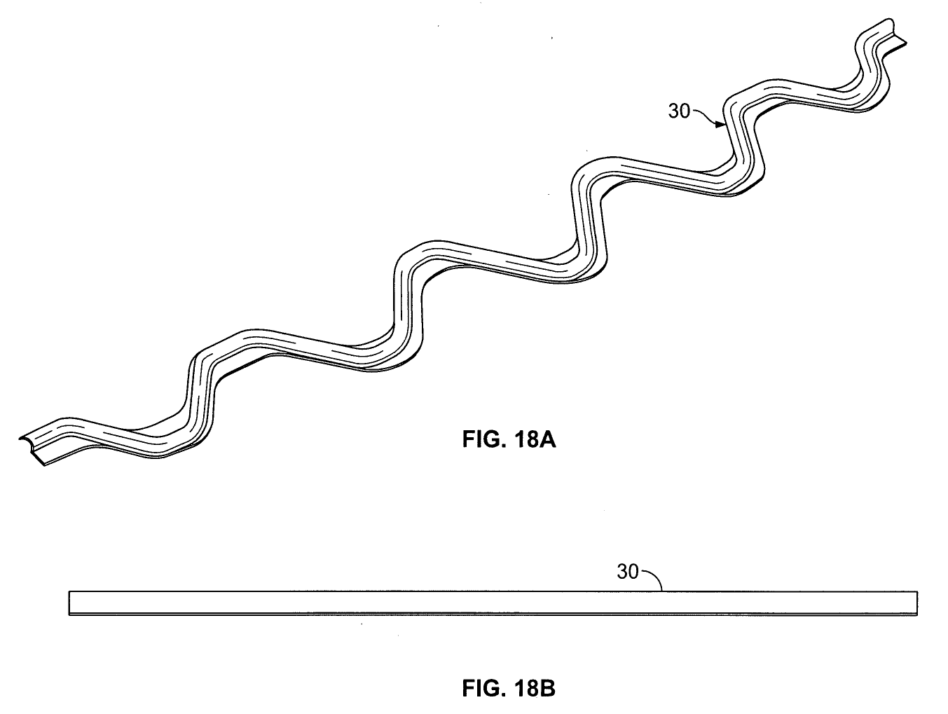

Various configurations of the inner panel 1 can be combined with various configurations of the outer panel 2. FIG. 13 depicts several examples of a straight, swept, and bent inner panel 1 combined with the outer panel 2. Other examples are possible as well.

### Second Example Embodiment

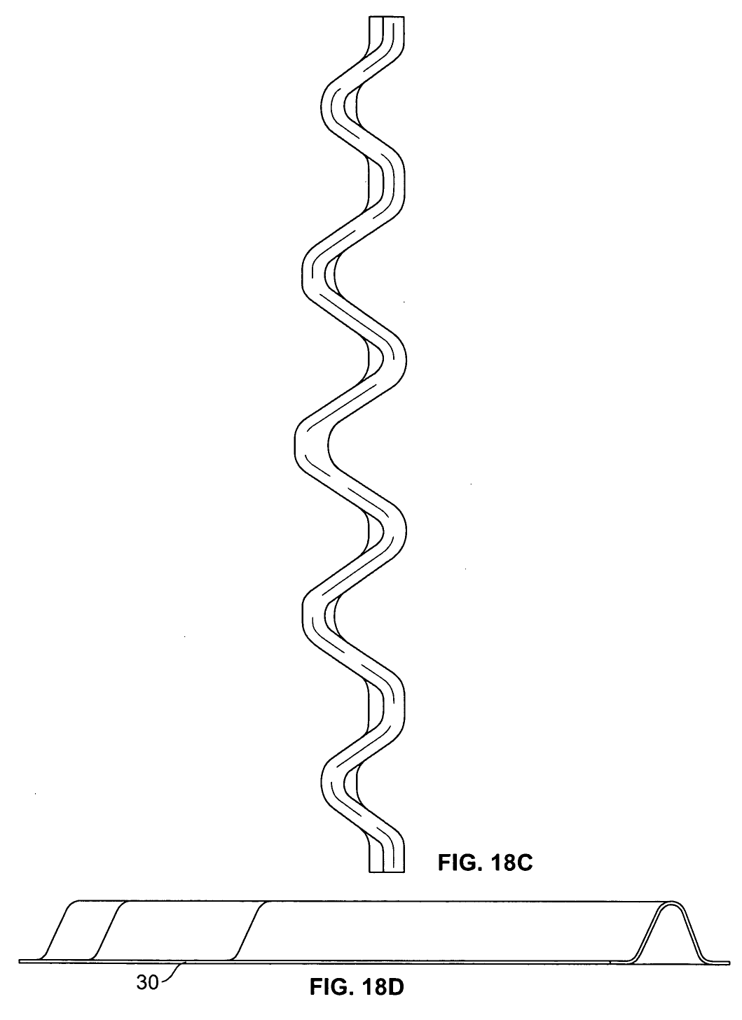

FIGS. 14-21 depict another example embodiment of the bumper system 10. FIG. 14 depicts an assembled bumper system 10, which can be attached to the front or back of a vehicle and can absorb some or all of an impact on that vehicle.

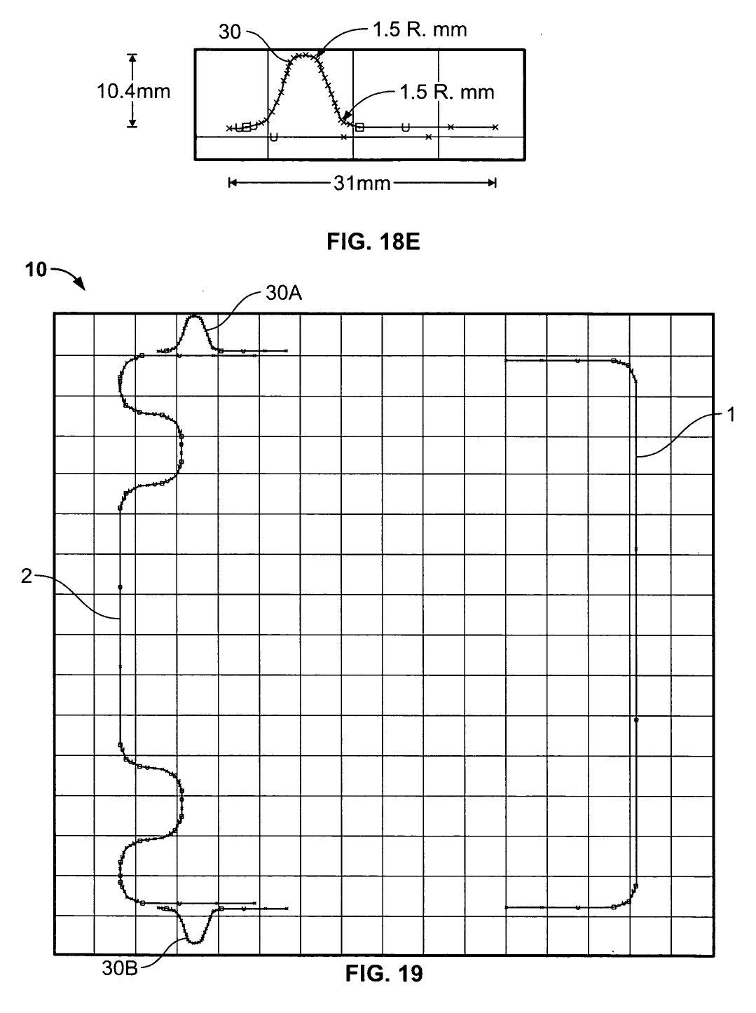

FIG. 15 depicts an exploded view of the bumper system 10 of FIG. 14. The example embodiment of FIGS. 14 and 15 includes an inner panel 1 that mounts to a frame of a vehicle. The inner panel 1 can be a formed open section, such as the C-shaped section depicted in FIG. 15, and can have a uniform cross section. The inner panel 1 can be formed of metal or metal alloys by rolling or stamping, although other examples are possible as well. As depicted in FIG. 15, the inner panel 1 can comprise a bent configuration, although other configurations, such as the example configurations depicted in FIGS. 3-6, are also possible. In one embodiment, the inner panel 1 is a roll formed high strength M220 steel (martensitic) C-shaped section. Other examples are possible as well.

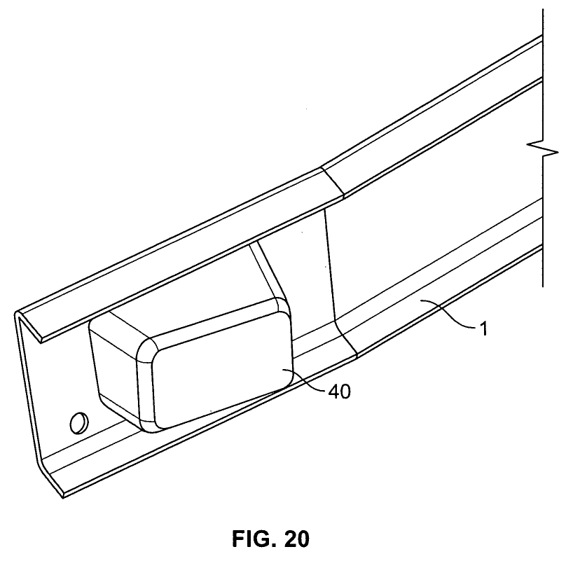

FIGS. 16A-16D depict several different views of the inner panel 1 of FIG. 15. FIG. 16A depicts an isometric view of the inner panel 1; FIG. 16B depicts a front view of the inner panel 1; FIG. 16C depicts a top view of the inner panel 1; and FIG. 16D depicts a side view of the inner panel 1.

As also depicted in FIG. 15, the example bumper system 10 can further include an outer panel 2, which provides a primary impact surface for the bumper system 10. The outer panel 2 can be a formed open section, such as the W-shaped section depicted in FIG. 15, and can have a uniform cross section. The outer panel 2 can be the same or different gauge as the inner panel 1, and likewise the outer panel 2 can comprise the same or different cross-sectional shape as the inner panel 1. The outer panel 2 can be formed of metal or metal alloys by rolling or stamping, although other examples are possible as well. As depicted in FIG. 15, the outer panel 2 can comprise a swept configuration, although other configurations, such as the example configurations depicted in FIG. 12, are also possible. In one embodiment, the outer panel 2 is a roll formed high strength M220 steel (martensitic) W-shaped section. In one embodiment, the outer panel 2 can be attached to the inner panel 1 by 2×120 mm welds at each end of the tops of the panels and by 2×120 mm welds at each end of the bottoms of the panels. Other examples are possible as well.

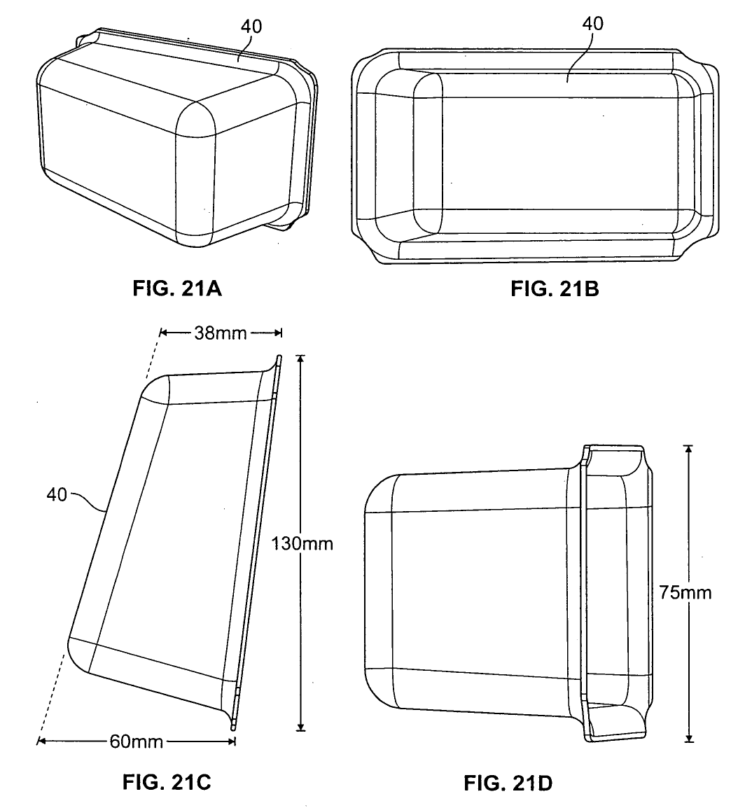

FIGS. 17A-17E depict several different views of the outer panel 2 of FIG. 15. FIG. 17A depicts an isometric view of the outer panel 2; FIG. 17B depicts a front view of the outer panel 2; FIG. 17C depicts a top view of the outer panel 2; FIG. 17D depicts a side view of the outer panel 2; and FIG. 17E depicts a section through the outer panel 2 showing the W-shape of the example outer panel 2 and some example dimensions.

Turning back to FIGS. 14 and 15, the example bumper system 10 can further include at least one support 30. The exploded view of FIG. 15 depicts the support 30 as an upper support 30A and a lower support 30B. The support 30 can provide a structure between the inner panel 1 and the outer panel 2, and is typically centered on the panels, although other locations are possible as well. Although two supports 30 are depicted in FIG. 15, in other embodiments there may be more or less supports 30. As depicted in FIGS. 14 and 15, the support 30 can comprise one or more wave shapes, wherein the tops of the waves can all be attached to one of the panels and the bottoms of the waves can all be attached to the other panel. In one embodiment, the center support 30 comprises a stamped, high strength RA120 steel support. In another embodiment, the center support 30 comprises a stamped, high strength DF140 steel support. Other examples and shapes are possible as well. In addition, in one embodiment, supports 30A and 30B can each be attached to the inner panel 1 and the outer panel 2 with 11×30 mm welds at each of the tops and bottoms of the one or more wave shapes.

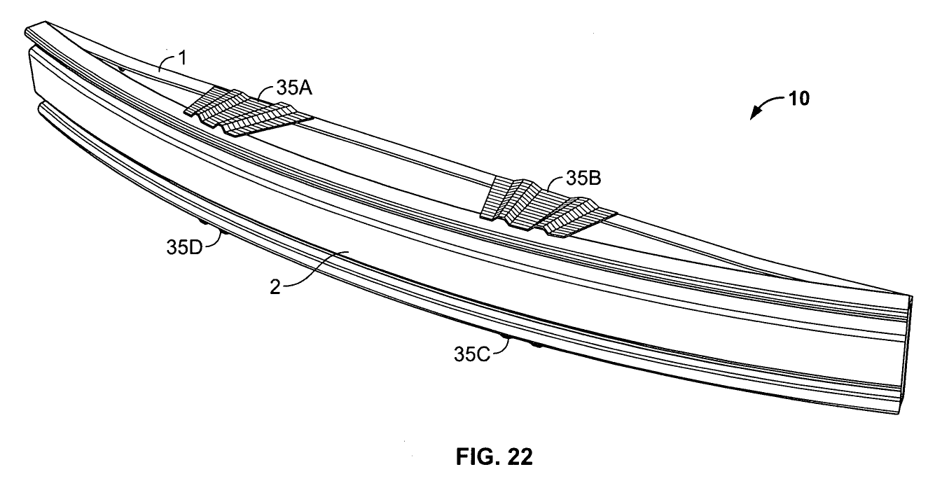

FIGS. 18A-18E depict several different views of the support 30 of FIG. 15. FIG. 18A depicts an isometric view of the support 30; FIG. 18B depicts a front view of the support 30; FIG. 18C depicts a top view of the support 30; FIG. 18D depicts a side view of the support 30; and FIG. 18E depicts a section through the support 30 and shows some example dimensions.

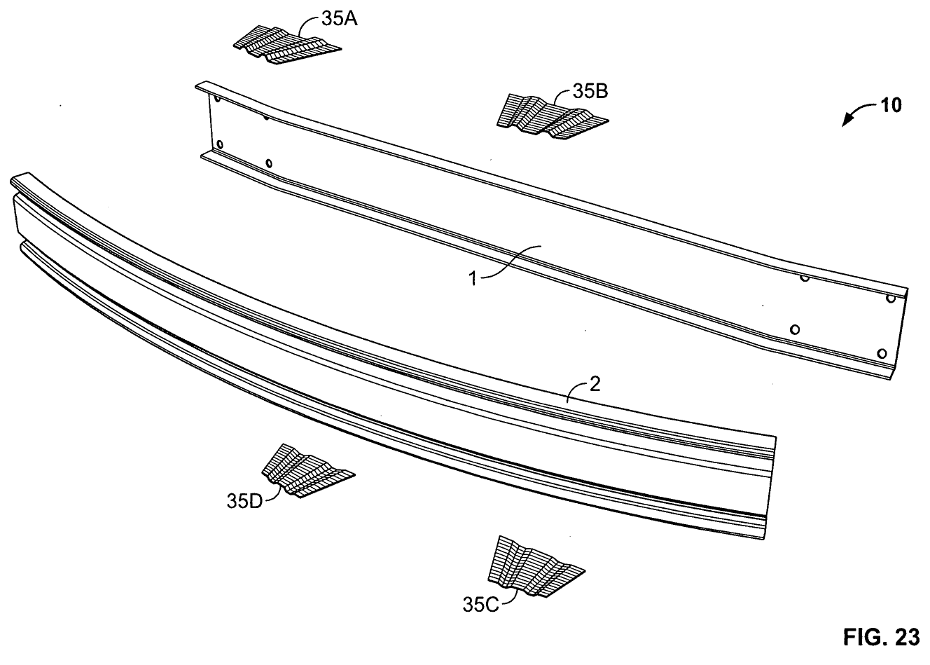

FIG. 19 depicts a cross-section through the bumper system 10 of FIG. 14, at a point at or near the center of the bumper system 10 along the width of a vehicle. As shown in FIG. 19, the outer panel 2 comprises a W-shaped cross-section and the inner panel 1 comprises a C-shaped section. FIG. 19 also depicts the profiles of a portion of support 30A and support 30B.

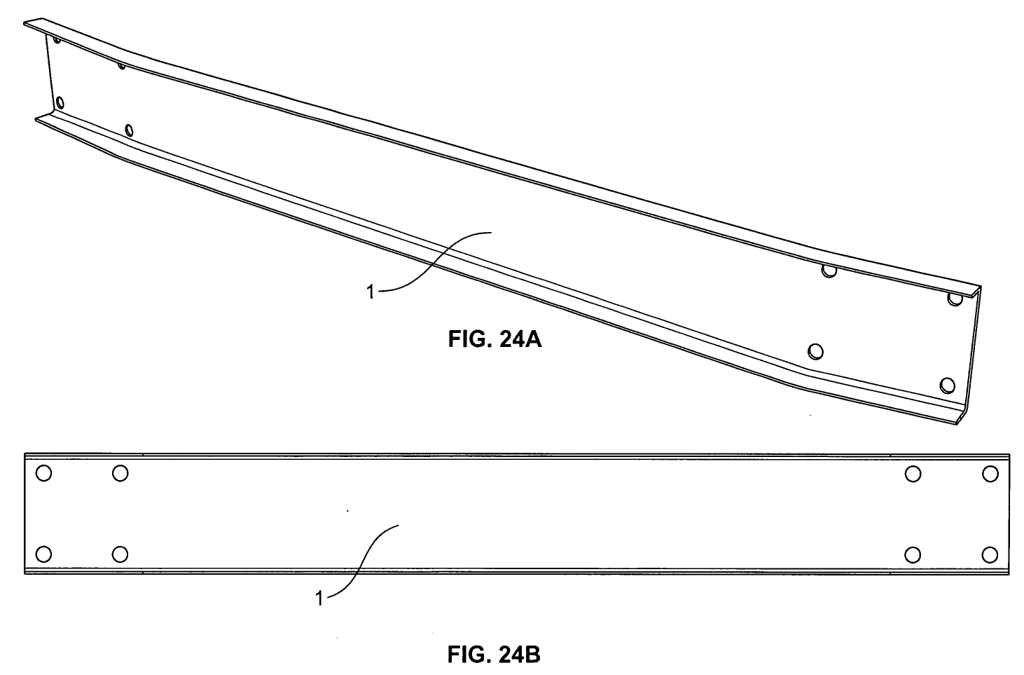

FIG. 20 depicts an example crushable module 40. In some embodiments, one or more modules 40 may be installed between the inner panel 1 and the outer panel 2. The modules 40 can be located at the ends of the inner panel 1 and the outer panel 2, or at the center of the inner panel 1 and the outer panel 2, although other locations are possible as well. In some embodiments, the crushable modules 40 are stamped from SAE 1010DQ steel. Further, in some embodiments, the crushable modules 40 can be attached to the inner panel 1 with 2×25 mm vertical welds, although other examples are possible as well.

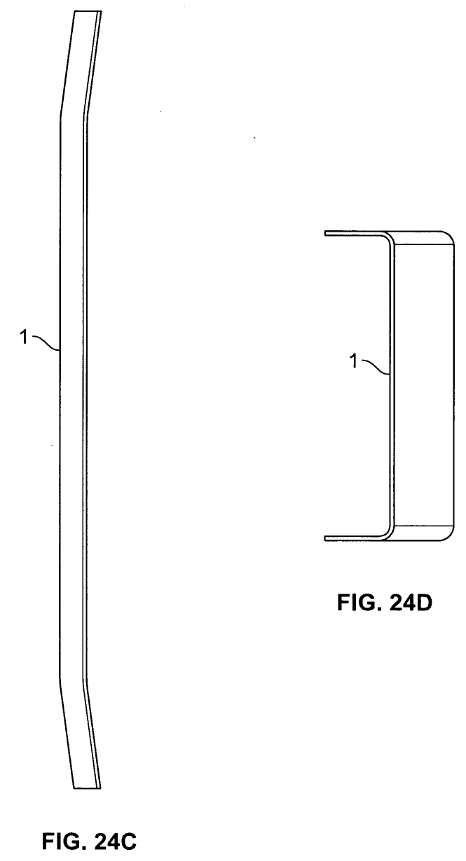

FIGS. 21 A-21D depict several different views of the crushable module 40 of FIG. 20. FIG. 21A depicts an isometric view of the crushable module 40; FIG. 21B depicts a front view of the crushable module 40; FIG. 21C depicts a top view of the crushable module 40 and shows some example dimensions; and FIG. 21D depicts a side view of the crushable module 40 and shows an example dimension.

### Third Example Embodiment

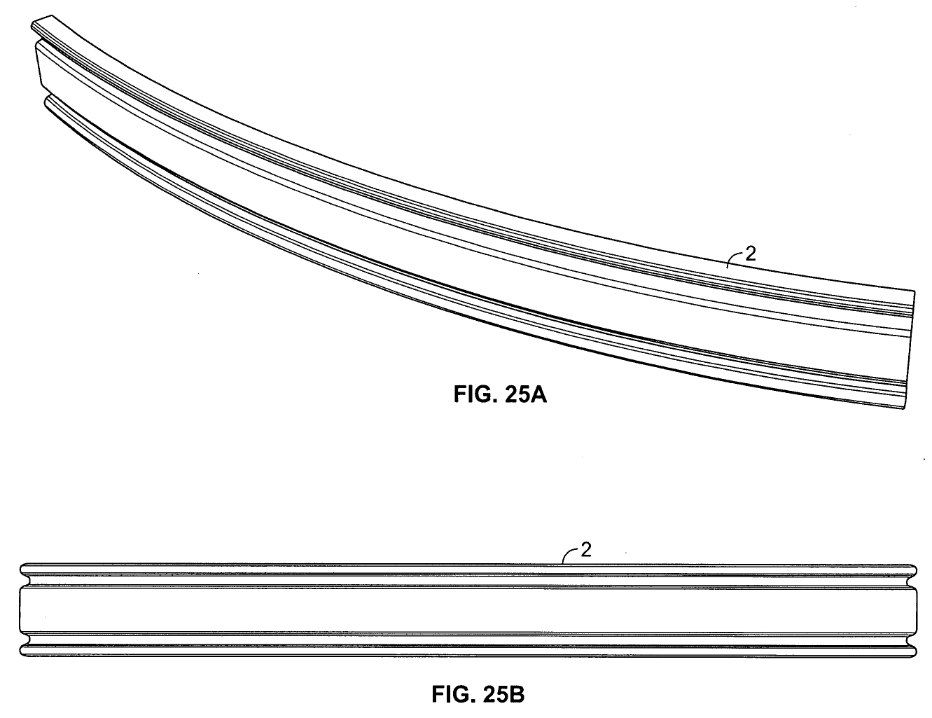

FIGS. 22-27 depict another example embodiment of the bumper system 10. FIG. 22 depicts an assembled bumper system 10, which can be attached to the front or back of a vehicle and can absorb some or all of an impact on that vehicle.

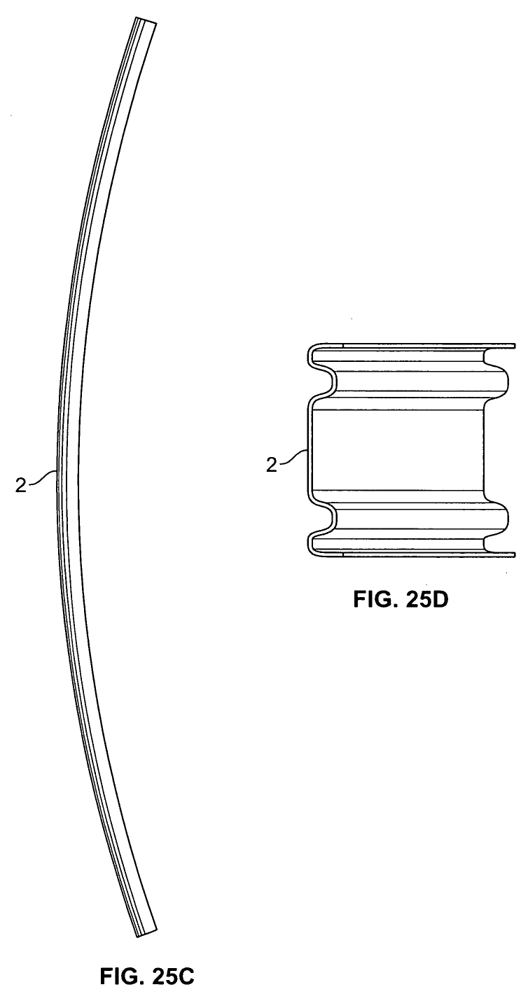

FIG. 23 depicts an exploded view of the bumper system 10 of FIG. 22. The example embodiment of FIGS. 22 and 23 includes an inner panel 1 that mounts to a frame of a vehicle. The inner panel 1 can be a formed open section, such as the C-shaped section depicted in FIG. 23, and can have a uniform cross section. The inner panel 1 can be formed of metal or metal alloys by rolling or stamping, although other examples are possible as well. As depicted in FIG. 23, the inner panel 1 can comprise a bent configuration, although other configurations, such as the example configurations depicted in FIGS. 3-6, are also possible. In one embodiment, the inner panel 1 is a roll formed high strength M220 steel (martensitic) C-shaped section. In another embodiment, the inner panel 1 is a roll formed high strength SAE 1010 steel C-shaped section. Other examples are possible as well.

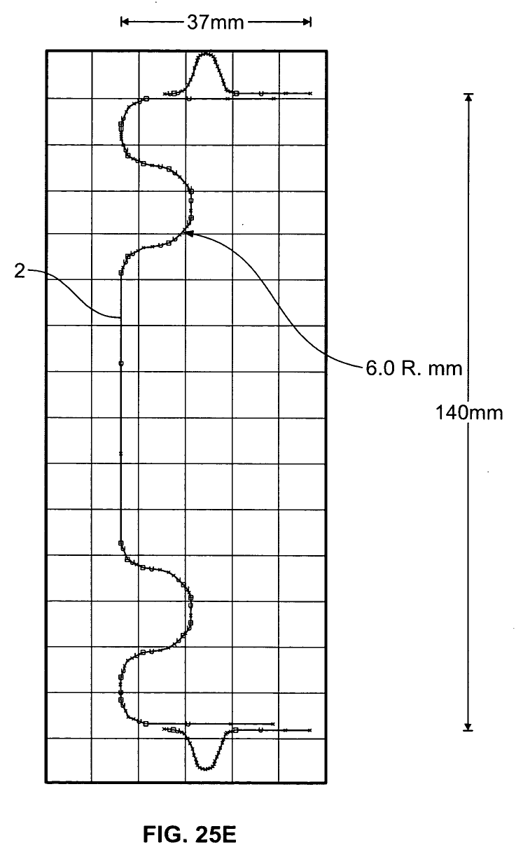

FIGS. 24A-24D depict several different views of the inner panel 1 of FIG. 23. FIG. 24A depicts an isometric view of the inner panel 1; FIG. 24B depicts a front view of the inner panel 1; FIG. 24C depicts a top view of the inner panel 1; and FIG. 24D depicts a side view of the inner panel 1.

As also depicted in FIG. 23, the example bumper system 10 can further include an outer panel 2, which provides a primary impact surface for the bumper system 10. The outer panel 2 can be a formed open section, such as the W-shaped section depicted in FIG. 23, and can have a uniform cross section. The outer panel 2 can be the same or different gauge as the inner panel 1, and likewise the outer panel 2 can comprise the same or different cross-sectional shape as the inner panel 1. The outer panel 2 can be formed of metal or metal alloys by rolling or stamping, although other examples are possible as well. As depicted in FIG. 23, the outer panel 2 can comprise a swept configuration, although other configurations, such as the example configurations depicted in FIG. 12, are also possible. In one embodiment, the outer panel 2 is a roll formed high strength M220 steel (martensitic) W-shaped section. In one embodiment, the outer panel 2 can be attached to the inner panel 1 by 2×120 mm welds at each end of the tops of the panels and by 2×120 mm welds at each end of the bottoms of the panels. Other examples are possible as well.

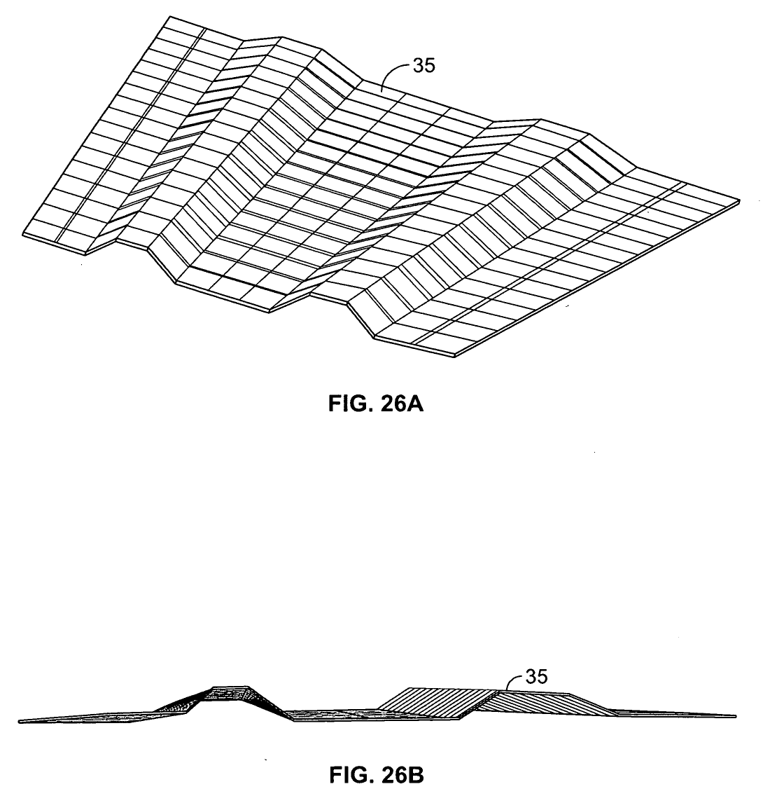

FIGS. 25A-25E depict several different views of the outer panel 2 of FIG. 23. FIG. 25A depicts an isometric view of the outer panel 2; FIG. 25B depicts a front view of the outer panel 2; FIG. 25C depicts a top view of the outer panel 2; FIG. 25D depicts a side view of the outer panel 2; and FIG. 25E depicts a section through the outer panel 2 and shows the W-shape of the example outer panel 2 and some example dimensions.

Turning back to FIGS. 22 and 23, the example bumper system 10 can further include at least one support 35. The exploded view of FIG. 23 depicts the support 35 as four contoured trapezoidal supports 35A-35D. The supports 35A-35D can provide a structure between the inner panel 1 and the outer panel 2. Although four supports 35 are depicted in FIG. 23, in other embodiments there may be more or less supports 35. In one embodiment, the support 35 comprises a stamped, high strength RA120 steel support. In another embodiment, the support 35 comprises a stamped, high strength SAE 1010 steel support. Other examples and shapes are possible as well. In addition, in one embodiment, each of supports 35A-35D can be attached to the inner panel 1 and the outer panel 2 with 6×30 mm welds (3 welds at the inner panel 1 and 3 welds at the outer panel 2), for a total of 24 welds for all of supports 35A-35D.

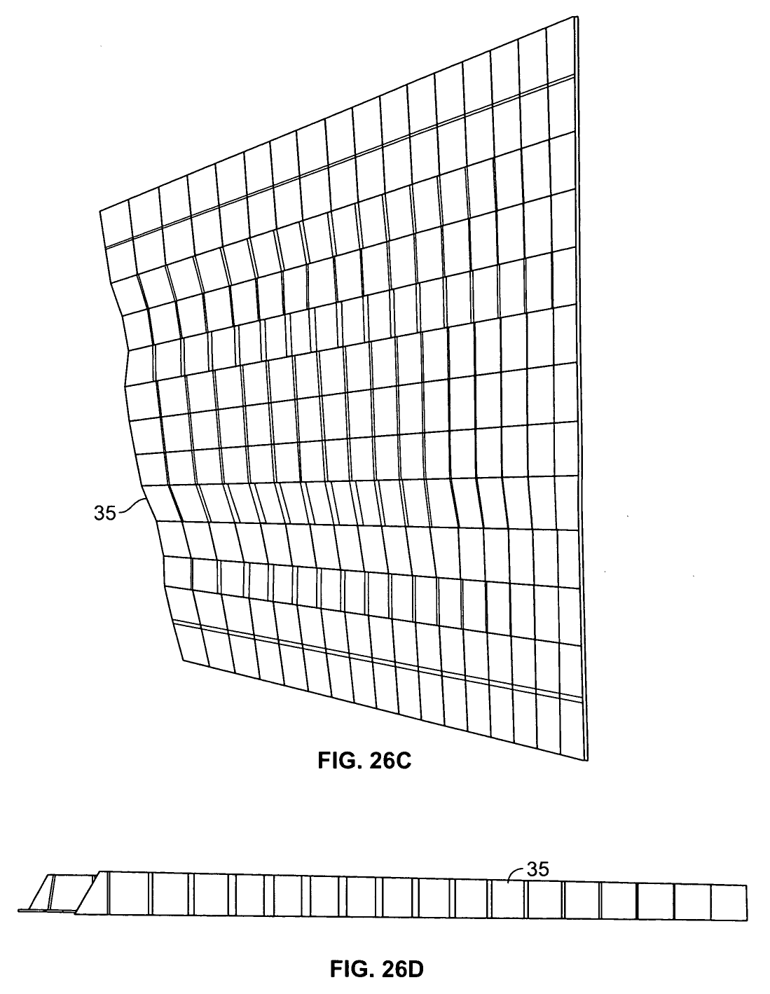

FIGS. 26A-26E depict several different views of the support 35 of FIG. 23. FIG. 26A depicts an isometric view of the support 35; FIG. 26B depicts a front view of the support 35; FIG. 26C depicts a top view of the support 35; and FIG. 26D depicts a side view of the support 30.

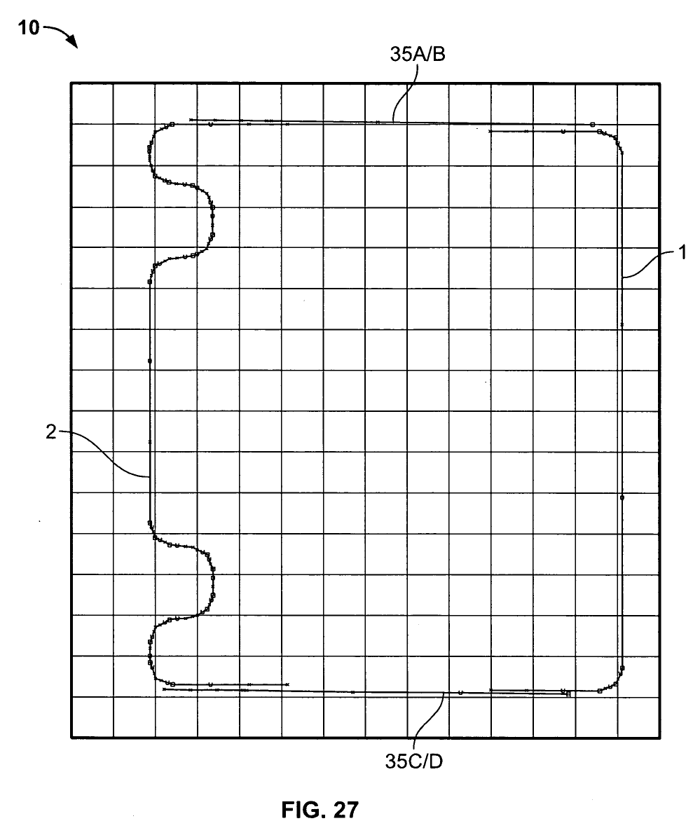

FIG. 27 depicts a cross-section through the bumper system 10 of FIG. 22, at a point at or near the center of the bumper system 10 along the width of a vehicle. As shown in FIG. 27, the outer panel 2 comprises a W-shaped cross-section and the inner panel 1 comprises a C-shaped section. FIG. 27 also depicts the profiles of a portion of supports 35A or 35B and support 35C or 35D.

Although not depicted in FIG. 22 or 23, this example embodiment of the bumper system 10 can also include crushable modules of the type depicted in FIGS. 20-21 and as discussed above.

### Conclusion

Several examples of particular embodiments of the present invention have been described above. Those skilled in the art will understand, however, that changes and modifications may be made to these embodiments without departing from the true scope and spirit of the present invention, which is defined by the claims.

We claim:

1. A bumper system comprising:
an outer panel with a length extending from a first end to a second end, the outer panel comprising a substantially uniform cross-section between the first end and the second end;
an inner panel with a length extending from a first end to a second end, the inner panel comprising a substantially uniform cross-section between the first end and the second end; and
wherein the first end of the outer panel is joined to the first end of the inner panel and the second end of the outer panel is joined to the second end of the inner panel.

2. The bumper system of claim 1, wherein the outer panel and the inner panel are connected by one or more supports.

3. The bumper system of claim 2, wherein the one or more supports can help absorb an impact to the bumper system.

4. The bumper system of claim 2, wherein the one or more supports comprise one support connecting the top of the outer panel to the top of the inner panel and one support connecting the bottom of the outer panel to the bottom of the inner panel.

5. The bumper system of claim 4, wherein the one or more supports comprise one or more wave-shaped supports, each wave-shaped support comprising one or more crests and one or more troughs, and wherein one or more crests of the waves connect to the inner panel and one or more troughs of the waves connect to the outer panel.

6. The bumper system of claim 2, wherein the one or more supports comprise two supports connecting the top of the outer panel to the top of the inner panel and two supports connecting the bottom of the outer panel to the bottom of the inner panel.

7. The bumper system of claim 6, wherein the one or more supports are substantially trapezoidal shaped.

8. The bumper system of claim 7, wherein the surfaces of the one or more supports comprise a contoured surface.

9. The bumper system of claim 1, wherein the substantially uniform cross-section of the outer panel is a different cross-section than the substantially uniform cross-section of the inner panel.

10. The bumper system of claim 1, wherein the outer panel comprises a swept profile, and the inner panel comprises a bent profile.

11. The bumper system of claim 1, further comprising one or more crushable modules located at each end of the inner panel and the outer panel.

12. The bumper system of claim 11, wherein the crushable modules can help absorb an impact to the bumper system.

13. A bumper system comprising:
an outer panel extending from a first end to a second end and comprising a substantially uniform cross-section between the first end and the second end;
an inner panel extending from a first end to a second end and comprising a substantially uniform cross-section between the first end and the second end; and
wherein the outer panel and the inner panel are connected by one or more supports.

14. The bumper system of claim 13, wherein the first end of the outer panel is joined to the first end of the inner panel and the second end of the outer panel is joined to the second end of the inner panel.

15. The bumper system of claim 13, wherein the one or more supports comprise one support connecting the top of the outer panel to the top of the inner panel and one support connecting the bottom of the outer panel to the bottom of the inner panel.

16. The bumper system of claim 13, wherein the one or more supports comprise one or more wave-shaped supports, each wave-shaped support comprising one or more crests and one or more troughs, and wherein one or more crests of the waves connect to the inner panel and one or more troughs of the waves connect to the outer panel.

17. The bumper system of claim 13, wherein the one or more supports comprise two supports connecting the top of the outer panel to the top of the inner panel and two supports connecting the bottom of the outer panel to the bottom of the inner panel.

18. The bumper system of claim 17, wherein the one or more supports are substantially trapezoidal shaped.

19. A method comprising:
joining a first end of an outer panel to a first end of an inner panel;
joining a second end of the outer panel to a second end of the inner panel; and
wherein the outer panel comprises a substantially uniform cross-section between the first end and the second end, and wherein the inner panel comprises a substantially uniform cross-section between the first end and the second end.

20. The method of claim 19, further comprising connecting one or more supports between the outer panel and the inner panel.
